(19) United States
(12) Patent Application Publication
(10) Pub. No.: US 2005/0180680 A1
(43) Pub. Date: Aug. 18, 2005

(54) Integrated optical devices and method of fabrication thereof

(76) Inventor: Eric Siu-Wai Kong, Sunnyvale, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/777,269

(22) Filed: Feb. 13, 2004

(51) Int. Cl. G02B 6/12; B29D 11/00

(52) U.S. Cl. 385/14; 385/141; 264/1.24

(57) ABSTRACT

An integrated optical device and a method of fabricating the integrated optical device comprising at least one waveguide structure is provided. The waveguide structure is fabricated from a dielectric material selected from either (a) a dielectric matrix having quantum dots dispersed therein or (b) an electro-optical polymer. The fabrication method of the present invention incorporates the technique of nano-imprinting (or nano-embossing) a film of dielectric material to define the shape of the waveguide structure. The integrated optical device is operable as one of the following: a wavelength converter, a modulator, a switch, a router, a wavelength filter and a dispersion compensator.

### FIELD OF THE INVENTION

This invention relates generally to integrated optical devices and a method of fabrication thereof.

### BACKGROUND OF THE INVENTION

In telecommunication networks, a solution for bandwidth expansion has been the adoption of wavelength division multiplexing (WDM), which entails the aggregation of many different information-carrying light streams on the same optical fiber. A WDM system that is configured for dividing and combining four or more wavelengths (or channels) that are closely spaced (800 gigahertz or less) is called dense wavelength division multiplexing (DWDM). Integrated optical devices are fundamentally required in these systems. Recently, integrated optical devices having ring resonators coupled to linear waveguides have been developed for use in these systems. One such device is disclosed by U.S. Pat. No. 6,608,947. This patent discloses a method of fabricating an optical device having one or more ring resonators optically coupled to linear waveguides. High index dielectric or semiconductor material is used to form the ring resonators and the linear waveguides. This method involves numerous, processing steps, which include deposition, patterning using photolithography, and etching.

There is also a rise in the use of optical polymers and organic materials for producing optical components. U.S. Pat. No. 5,764,820 discloses a method of forming an integrated electro-optical device having a polymeric waveguide structure. The polymeric materials to be used for the waveguide structure include non-linear optical (NLO) polymers.

In recent years, there has been an increasing interest in synthesizing nanocomposite materials that have applications in the optical communications industry. Nanocomposites containing embedded quantum dots have been recently developed to exploit the extraordinary properties associated with quantum dots. Quantum dots exhibit photoluminescence with high quantum yields.

There remains a need in the industry for an integrated optical device having components made of nanocomposites or photonic polymers, which can be fabricated by an easily-practiced and low cost process.

### SUMMARY OF THE INVENTION

The present invention provides for the fabrication of an integrated optical device comprising at least one waveguide structure. The waveguide structure is fabricated from a dielectric material selected from either (a) a dielectric matrix having quantum dots dispersed therein or (b) an electro-optical polymer. The fabrication method of the present invention incorporates the technique of nano-imprinting (or nano-embossing) a film of dielectric material to define the shape of the waveguide structure. The integrated optical device of the present invention is operable as one of the following: a wavelength converter, a modulator, a switch, a router, a wavelength filter and a dispersion compensator.

The advantages and novel features of the present invention will become apparent from the following detailed description of the preferred embodiments of the invention when considered in conjunction with the accompanying drawings.

### BRIEF DESCRIPTION OF THE DRAWINGS

FIG. 1 illustrates a quantum dot that is useful in the present invention.

FIGS. 2-5 illustrate the basic steps for fabricating an optical device according to an embodiment of the present invention.

FIG. 6 shows the top plan view of the stamp to be used in nano-imprinting according to the present invention.

FIG. 7 shows a cross-sectional view of the stamp shown in FIG. 6.

### DETAILED DESCRIPTION OF THE INVENTION

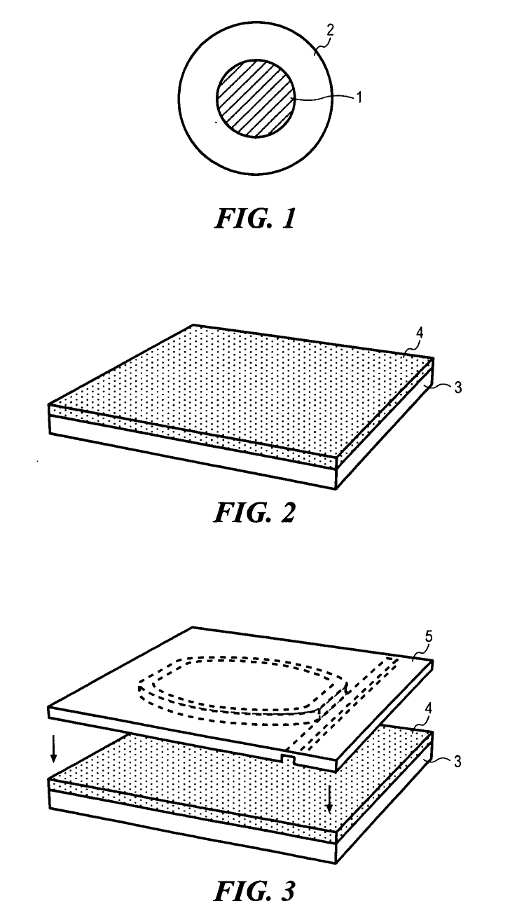

The integrated optical device in accordance with one embodiment of the invention comprises a ring resonator coupled to a straight waveguide structure, wherein both structures are formed from a dielectric matrix containing dispersed quantum dots. This embodiment of the present invention exploits the extraordinary optical and electronic properties of quantum dots. The quantum dots may be made of the following materials: (i) Group II-VI semiconductor materials, including but not limited to ZnS, ZnSe, ZnTe, CdS, CdSe, and CdTe; (ii) lead chalogenides, including but not limited to PbS, PbSe, and PbTe; or (iii) metals having nonlinear susceptibility when introduced into a dielectric host, for example, gold and silver. A quantum dot may comprise a single-material particle or a core surrounded by a shell. FIG. 1 illustrates a core 1 of a first material surrounded by a shell 2 of a second material. Some examples of the core/shell combination are ZnS core/CdS shell, and Au core/CdS shell. The quantum dots are typically in a size range between about 1-50 nm, preferably below 3 nm. It is especially preferred that the quantum dots being dispersed in the dielectric matrix have uniform diameters of 2 nm.

The dielectric matrix material that is used to host the quantum dots may be selected from a broad range of polymers that are highly compatible with the quantum dots and have optical properties. Some examples are poly(methylmethacrylate) (PMMA), polystyrene, polycarbonate, polyimide and polysiloxane. The preferred polymers are non-linear optical (NLO) polymers, including but not limited to polyphenylacetylene, and Nafion™ (a nonlinear optical polymer available from DuPont). NLO polymers are especially preferred because of their linear electro-optical effects that are important for electro-optical applications. The quantum dots interact with the functional groups on the non-linear optical polymer matrix in order to enhance the optical properties, such as the χ−3, non-linear optical susceptibility. The higher the χ−3, the more the nano-composite would be suitable to perform optical switching. The quantum dots are chosen from II-VI semiconductors, III-V semiconductors and lead chalcogenides in order to embed the quantum dots into different polymers. The properties are screened using various standard techniques, well-known in the art, such as femto-second laser spectroscopy in order to evaluate the χ−3 parameter.

FIGS. 2-5 illustrate the main steps of fabricating an integrated optical device having a ring resonator coupled to a straight waveguide in accordance with the preferred embodiment of the present invention. Referring to FIG. 2, a dielectric film 4 comprising quantum dots dispersed therein is formed on a substrate 3, preferably a silicon substrate. The thickness of the dielectric film 4 is preferably about 50-200 nm. Two techniques may be used for forming the dielectric film 4 having dispersed quantum dots on the substrate. According to the first technique, a liquid monomer for forming the above mentioned polymeric matrix is selected, and quantum dots are mixed with the liquid monomer. This mixture is then spin-coated onto the substrate 3. Heating is carried out to polymerize the monomer and to solidify the mixture into the dielectric film 4. According to the second technique, a selected polymeric matrix material is dissolved in a solvent and the polymer solution is spin-coated onto the substrate. The solvent is removed after spin-coating. Quantum dots are then dispersed into the polymeric matrix material by an ion-exchange process, whereby producing the dielectric film 4. The polymeric matrix is prepared so that it has a high content of quantum dots, preferably 60% or higher.

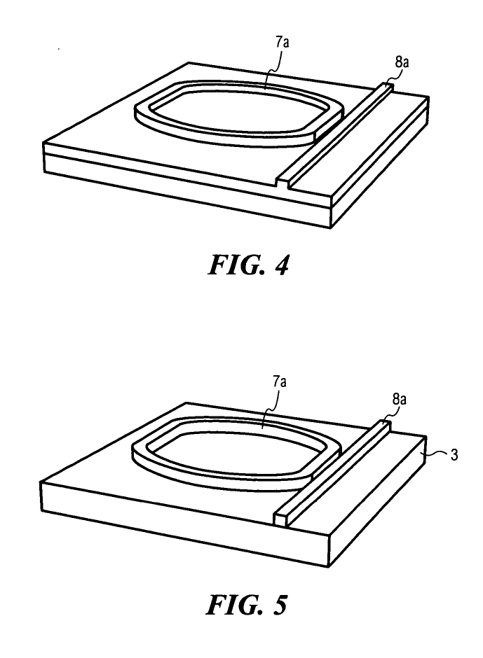

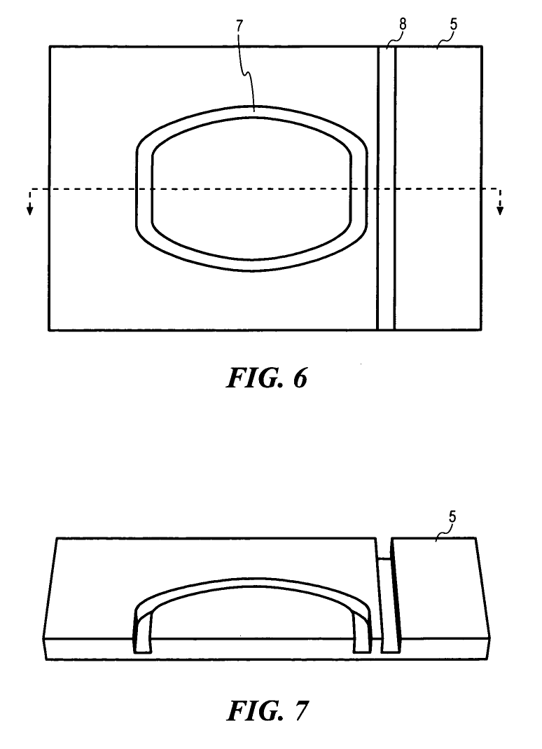

Referring to FIG. 3, a stamp 5 is imprinted onto the dielectric film 4 to deform the physical shape of the dielectric film 4. Referring to FIG. 6, the stamp 5 has a ring-shaped trench 7 and a linear trench 8 that replicate the shapes of the ring resonator and the straight waveguide structure to be produced, respectively. FIG. 7 shows a cross-sectional view of the stamp 5 formed by cut line I-I shown in FIG. 6. The stamp 5 may be made of silicon, SiO₂ or a metal, e.g., nickel. During imprinting, both the mold and the coated substrate are heated or just the coated substrate is heated. The heating temperature during imprinting is above the glass transition temperature (T_{g}) of the polymeric matrix material selected. For example, if PMMA (T_{g} of 100° C.) is the polymeric matrix material then the heating temperature may be above 150° C., preferably 190° C. The stamp 5 and the dielectric film 4 are pressed together at this heating temperature for about 1-10 minutes, followed by cooling down to below T_{g} so as to harden the dielectric film. After the dielectric film is hardened, the mold is separated from the dielectric layer resulting in a raised pattern of a ring resonator 7a coupled to a straight waveguide 8a as shown in FIG. 4. It is preferred that a releasing agent is provided on the surface of the stamp in order to improve the resolution of the imprinting and improve the minimal feature size. Etching is then carried out to remove the excess matrix material surrounding the raised structures 7a and 8a, thereby exposing the top surface of the substrate 3 as shown in FIG. 5. The etching step may be done by wet etching using buffered HF. Etching also increases the aspect ratio of the side wall surfaces of raised structures 7a and 8a.

In the second embodiment of the present invention, the dielectric film to be imprinted is made of an electro-optic polymer. The preferred electro-optic polymer is one which has a highly polymerizable chromophore in its back bone or side chain. As an example, electro-optic polymers available from Pacific Wave Industries, Inc., CA (US) are suitable for the purpose of the present invention. The electro-optic polymer in the form of a solvent-based solution is coated onto a substrate, preferably by spin-coating. The solvent is then evaporated from the polymeric coating to form a solidified polymer film. The same imprinting, cooling and etching steps are then carried out as described above for FIGS. 3-5 to produce a ring resonator coupled to a straight waveguide structure.

It should be understood that two or more ring resonators in combination with two or more straight waveguide structures may be produced by the method of the present invention.

The invented method of fabricating the basic device having a ring resonator coupled to a straight waveguide may be incorporated in the fabrication of one of the following optical devices: a wavelength converter, a modulator, a switch, a router, a wavelength filter and a dispersion compensator.

There are two kinds of nanoimprinting techniques: (1) hot embossing and (2) cold embossing involving ultraviolet lithography. Either technique may be used in the method of the present invention. The principal process steps for an UV-NIL process are:
(1) Loading of stamp and spin coated substrate;
(2) Adjusting of a certain separation gap between stamp and substrate;
(3) Rough alignment of stamp and substrate in adjusted separation;
(4) Moving to soft contact of stamp and resist;
(5) Fine alignment of stamp and polymer in soft contact;
(6) Vacuum contact between stamp and resist;
(7) Curing of imprinted features by UV-exposure;
(8) Demolding of stamp and imprinted substrate;
(9) Unloading of imprinted substrate;
(10) Loading of next substrate; and
(11) Returning to step (2).

The present invention has numerous advantages over existing developments, including:
(a) The inventive method can produce waveguide structures with small feature sizes of sub-50 nm resolution.
(b) The present invention provides a high-throughput, easily practiced and low cost fabrication method that eliminates multi-stage etching procedures.
(c) The polymer waveguides with very smooth sidewalls can be fabricated, thereby producing very little scattering loss.
(d) Tunable micro-ring structures can be fabricated for resonator or modulator applications. During the fabrication of the micro-rings, the exact size can be easily controlled.

Although certain preferred embodiments have been shown and described, it should be understood to those skilled in the art that many changes and modifications may be made therein without departing from the spirit and scope of the invention as defined by the appended claims.

1. A method of fabricating an integrated optical device having at least one waveguide structure comprising the steps of:
a) forming a dielectric film layer on a substrate;
b) heating said dielectric film layer;
c) pressing said dielectric film layer against a stamp having a pattern of at least one waveguide structure formed thereon;
d) compressing said stamp and said dielectric film layer;
e) cooling said dielectric film layer; and,
f) removing said stamp from said dielectric film layer, thereby producing at least one waveguide structure on said substrate.

2. The method of fabricating an integrated optical device having at least one waveguide structure as recited in claim 1 wherein said dielectric film layer is formed from an electro-optic polymer.

3. The method of fabricating an integrated optical device having at least one waveguide structure as recited in claim 1 wherein said dielectric film layer is formed from a dielectric matrix having quantum dots dispersed therein.

4. The method of fabricating an integrated optical device having at least one waveguide structure as recited in claim 1 further comprising the step of removing excess dielectric material surrounding said at least one waveguide following said step of removing said stamp.

5. The method of fabricating an integrated optical device having at least one waveguide structure as recited in claim 4, wherein said step of removing said excess dielectric material is performed by wet etching using a buffered HF solution.

6. The method of fabricating an integrated optical device having at least one waveguide structure as recited in claim 1, wherein said at least one waveguide structure is a substantially straight waveguide.

7. The method of fabricating an integrated optical device having at least one waveguide structure as recited in claim 1, wherein said dielectric film layer is formed of a polymeric matrix having quantum dots dispersed therein.

8. The method of fabricating an integrated optical device having at least one waveguide structure as recited in claim 3, wherein said quantum dots are formed from a material selected from the group consisting of Group II-VI semiconductor, lead chalogenides, and metals having nonlinear susceptibility when introduced into a dielectric host.

9. The method of fabricating an integrated optical device having at least one waveguide structure as recited in claim 7, wherein said quantum dots are formed from a material selected from the group consisting of Group II-VI semiconductor, lead chalogenides, and metals having nonlinear susceptibility when introduced into a dielectric host.

10. The method of fabricating an integrated optical device having at least one waveguide structure as recited in claim 7, wherein said polymeric matrix is a non-linear optical polymer.

11. The method of fabricating an integrated optical device having at least one waveguide structure as recited in claim 10, wherein said non-linear optical polymer is polyphenylacetylene.

12. The method of fabricating an integrated optical device having at least one waveguide structure as recited in claim 7 wherein said dielectric film layer is heated to a temperature above the glass transition temperature of said polymeric matrix during formation of said at least one waveguide structure on said substrate.

13. The method of fabricating an integrated optical device having at least one waveguide structure as recited in claim 7 wherein said quantum dots are formed having a substantially uniform volume.

14. The method of fabricating an integrated optical device having at least one waveguide structure as recited in claim 7 wherein said quantum dots form at least 60% of the volume of said polymeric matrix.

15. The method of fabricating an integrated optical device having at least one waveguide structure as recited in claim 7 wherein each said quantum dot comprises a core and a shell surrounding said core.

16. The method of fabricating an integrated optical device having at least one waveguide structure as recited in claim 1 wherein said dielectric film layer is formed of an electro-optic polymer having a highly polymerizable chromophore in its backbone or side chain.

17. The method of fabricating an integrated optical device having at least one waveguide structure as recited in claim 1 wherein said step of forming said dielectric film layer on said substrate includes spin-coating said dielectric film layer on said substrate.

18. The method of fabricating an integrated optical device having at least one waveguide structure as recited in claim 1 further comprising the step of heating said stamp prior to said step of compressing said stamp and said dielectric film layer.

19. A method of fabricating an integrated optical device having at least one ring resonator comprising the steps of:
a) forming a dielectric film layer on a substrate;
b) heating said dielectric film layer;
c) pressing said dielectric film layer against a stamp having a pattern of at least one ring resonator formed thereon;
d) compressing said stamp and said dielectric film layer;
e) cooling said dielectric film layer; and,
f) removing said stamp from said dielectric film layer, thereby producing at least one ring resonator on said substrate.

20. The method of fabricating an integrated optical device having at least one ring resonator as recited in claim 19 wherein said dielectric film layer is formed from an electro-optic polymer.

21. The method of fabricating an integrated optical device having at least one ring resonator as recited in claim 19 wherein said dielectric film layer is formed from a dielectric matrix having quantum dots dispersed therein.

22. The method of fabricating an integrated optical device having at least one ring resonator as recited in claim 19 further comprising the step of removing excess dielectric material surrounding said at least one ring resonator following said step of removing said stamp.

23. The method of fabricating an integrated optical device having at least one ring resonator as recited in claim 22, wherein said step of removing said excess dielectric material is performed by wet etching using a buffered HF solution.

24. The method of fabricating an integrated optical device having at least one ring resonator as recited in claim 19, wherein said dielectric film layer is formed of a polymeric matrix having quantum dots dispersed therein.

25. The method of fabricating an integrated optical device having at least one ring resonator as recited in claim 21, wherein said quantum dots are formed from a material selected from the group consisting of Group II-VI semiconductor, lead chalogenides, and metals having nonlinear susceptibility when introduced into a dielectric host.

26. The method of fabricating an integrated optical device having at least one ring resonator as recited in claim 24, wherein said quantum dots are formed from a material selected from the group consisting of Group II-VI semiconductor, lead chalogenides, and metals having nonlinear susceptibility when introduced into a dielectric host.

27. The method of fabricating an integrated optical device having at least one ring resonator as recited in claim 24, wherein said polymeric matrix is a non-linear optical polymer.

28. The method of fabricating an integrated optical device having at least one ring resonator as recited in claim 27, wherein said non-linear optical polymer is polyphenylacetylene.

29. The method of fabricating an integrated optical device having at least one ring resonator as recited in claim 24 wherein said dielectric film layer is heated to a temperature above the glass transition temperature of said polymeric matrix during formation of said at least one waveguide structure on said substrate.

30. The method of fabricating an integrated optical device having at least one ring resonator as recited in claim 24 wherein said quantum dots are formed having a substantially uniform volume.

31. The method of fabricating an integrated optical device having at least one ring resonator as recited in claim 24 wherein said quantum dots form at least 60% of the volume of said polymeric matrix.

32. The method of fabricating an integrated optical device having at least one ring resonator as recited in claim 24 wherein each said quantum dot comprises a core and a shell surrounding said core.

33. The method of fabricating an integrated optical device having at least one ring resonator as recited in claim 19 wherein said dielectric film layer is formed of an electro-optic polymer having a highly polymerizable chromophore in its backbone or side chain.

34. The method of fabricating an integrated optical device having at least one ring resonator as recited in claim 19 wherein said step of forming said dielectric film layer on said substrate includes spin-coating said dielectric film layer on said substrate.

35. The method of fabricating an integrated optical device having at least one ring resonator as recited in claim 19 further comprising the step of heating said stamp prior to said step of compressing said stamp and said dielectric film layer.

36. The method of fabricating an integrated optical device having at least one ring resonator as recited in claim 19 wherein said stamp further has a pattern of at least one straight waveguide formed thereon.

37. An integrated optical device comprising:
a substrate layer;
a dielectric layer formed on said substrate layer, at least one waveguide structure being formed in said dielectric layer.

38. The integrated optical device as recited in claim 37 wherein said at least one waveguide structure is a substantially straight waveguide.

39. The integrated optical device as recited in claim 37 wherein said dielectric film layer is formed of a polymeric matrix having quantum dots dispersed therein.

40. The integrated optical device as recited in claim 37 wherein said dielectric film layer is formed of a dielectric matrix having quantum dots dispersed therein.

41. The integrated optical device as recited in claim 39 wherein said quantum dots are formed of material selected from the group consisting of Group II-VI semiconductor, lead chalogenides, and metals having nonlinear susceptibility when introduced into a dielectric host.

42. The integrated optical device as recited in claim 40 wherein said quantum dots are formed of material selected from the group consisting of Group II-VI semiconductor, lead chalogenides, and metals having nonlinear susceptibility when introduced into a dielectric host.

43. The integrated optical device as recited in claim 39 wherein said polymeric matrix is a non-linear polymer.

44. The integrated optical device as recited in claim 43 wherein said non-linear polymer is polyphenylacetylene.

45. The integrated optical device as recited in claim 39 wherein said quantum dots have a substantially uniform volume.

46. The integrated optical device as recited in claim 40 wherein said quantum dots have a substantially uniform volume.

47. The integrated optical device as recited in claim 39 wherein said quantum dots form at least 60% of said polymeric matrix by volume.

48. The integrated optical device as recited in claim 39 wherein each said quantum dot comprises a core and a shell surrounding said core.

49. The integrated optical device as recited in claim 40 wherein each said quantum dot comprises a core and a shell surrounding said core.

50. The integrated optical device as recited in claim 37 wherein said dielectric film layer is formed of an electro-optic polymer having a highly polymerizable chromophore in its backbone or side chain.

51. The integrated optical device as recited in claim 37 wherein said integrated optical device is a wavelength converter.

52. The integrated optical device as recited in claim 37 wherein said integrated optical device is a modulator.

53. The integrated optical device as recited in claim 37 wherein said integrated optical device is a switch.

54. The integrated optical device as recited in claim 37 wherein said integrated optical device is a router.

55. The integrated optical device as recited in claim 37 wherein said integrated optical device is a wavelength filter.

56. The integrated optical device as recited in claim 37 wherein said integrated optical device is a dispersion compensator.
